(19) United States
(12) Patent Application Publication
(10) Pub. No.: US 2008/0143038 A1
(43) Pub. Date: Jun. 19, 2008

(54) Paper separating device, fixing device, paper conveyance device, and image forming apparatus

(75) Inventor: Masakazu Uehara, Osaka (JP)

Correspondence Address: SMITH, GAMBRELL & RUSSELL, 1130 CONNECTICUT AVENUE, N.W., SUITE 1130, WASHINGTON, DC, 20036, US

(73) Assignee: KYOCERA MITA CORPORATION

(21) Appl. No.: 12/000,302

(22) Filed: Dec. 11, 2007

(30) Foreign Application Priority Data
Dec. 13, 2006 (JP) 2006-335295

(51) Int. Cl. B65H 3/32; B41F 13/00

(52) U.S. Cl. 271/18; 270/1.01

(57) ABSTRACT

Downstream of a paper conveying member arranged in a paper conveyance path of an image forming apparatus, a pair of separating claws separating paper from the paper conveying member are so arranged as to be spaced apart from each other in the paper width direction. Of guide ribs guiding the separated paper to a downstream side of the paper conveyance path, the guide ribs adjacent to the pair of the separating claws have larger amounts of projection toward a paper conveyance plane at upstream ends in a paper conveyance direction than the guide rib located between these guide ribs.

This application is based on Japanese Patent Application No. 2006-335295 filed on Dec. 13, 2006, the contents of which are hereby incorporated by reference.

### BACKGROUND OF THE INVENTION

1. Field of the Invention

The present invention relates to a paper separating device, a fixing device, and a paper conveying device included in an image forming apparatus, such as a copier, a printer, a facsimile, or the like, and also to the image forming apparatus itself.

2. Description of Related Art

As electrophotographic image forming apparatuses, copiers, facsimiles, laser printers, etc. are well-known. With these image forming apparatuses, the surface of a photoconductive drum uniformly charged is selectively exposed to thereby form an electrostatic latent image, which is then developed with a toner, and the toner is transferred onto paper, and the transferred toner is fixed on the paper with a fixing device.

As the fixing device described above, various configurations are used. In one configuration example of the fixing device, a fixing roller having a heater built therein and a pressure roller pressure-contacted by this fixing roller to thereby form a fixing nip part are provided, and heat and pressure are added to paper passing through the fixing nip part to fix a non-fixed toner onto the paper.

In the fixing device having the configuration described above, in order to prevent a phenomenon that paper is wound around the fixing roller due to an adhesive force of the molten toner, a separating claw for separating paper is combined with the fixing roller. As this separating claw, a plurality of separating claws are arranged at an area downstream of the fixing nip in the paper conveyance direction in such a manner as to be spaced apart from each other in a paper width direction. Moreover, provided at an area downstream of the fixing nip part in the paper conveyance direction are a plurality of guide ribs for guiding paper separated from the fixing roller by the separating claws toward the downstream side in the paper conveyance direction.

Although a plurality of separating claws are arranged, the widthwise both ends of paper inevitably project outward of the separating claws. The projecting portion bends toward the fixing roller in many cases. In some cases, this bent portion is not successfully guided by the guide ribs and becomes stuck at the leading ends of the guide ribs, thus causing paper jam.

A paper separating device of an image forming apparatus described in JP-A-2005-257992 includes the following structure for the purpose of solving the problem described above. Specifically, a plurality of separating claws are so arranged as to be asymmetric to a paper conveyance reference position. Between the adjacent separating claws, a plurality of guide ribs are arranged, the height of which is so designed as to be lower as they separates further away from the paper conveyance reference position. Such configuration permits the widthwise ends of paper to be loaded on the guide ribs without being stuck in the leading ends of the guide ribs and be thereby reliably guided toward the downstream side of a paper conveyance path.

However, in the case of the image forming apparatus described in JP-A-2005-257992, separation of the paper end, which is about to pass through the separating claws, from a heating roller proceeds quickly at the separation claws, but as the paper end is located further away from the separating claws, that is, as it is located closer to the center between the separating claws, the separation of the paper end from the heating roller is delayed and, as a result, the paper end makes contact there with the heating roller for a longer period of time than at a portion closer to the separating claws. In this manner, the portion making contact with the heating roller for a longer period of time is accordingly more likely to bend in a direction perpendicular to the plane of the paper conveyance path and become stuck in the leading ends of the guide ribs.

### SUMMARY OF THE INVENTION

In view of the problem described above, the present invention has been made, and it is an object of the invention to provide a paper separating device for an image forming apparatus in which paper separating device, even when the end of paper separated from a conveyance member bends, the paper end is guided toward the downstream side of a paper conveyance path without causing paper jam.

To achieve the object described above, according to one aspect of the invention, a paper separating device includes: a conveying member arranged in a paper conveyance path and conveying paper in contact therewith; a plurality of separating claws arranged downstream of the conveying member and separating the paper from the conveying member and guiding the paper to a downstream side of the paper conveyance path; and a plurality of guide ribs arranged between a pair of the adjacent separating claws and guiding the paper separated from the conveying member by the separating claws to the downstream side of the paper conveyance path. The guide ribs project toward a paper conveyance plane from a base section provided between the pair of the adjacent separating claws. The guide ribs further include the guide ribs adjacent to the pair of the separating claws, and the guide rib having a smaller amount of projection toward the paper conveyance plane at an upstream end in a paper conveyance direction than the guide ribs adjacent to the pair of the separating claws.

### BRIEF DESCRIPTION OF THE DRAWINGS

These and other objects and features of the present invention will be clarified with reference to the following description of the preferred embodiments, which will be given with reference to the following drawings.

FIG. 1 is a pattern diagram showing the overall configuration of an image forming apparatus loaded with a paper separating device according to the present invention;

FIG. 2 is a sectional view of a fixing device portion in the image forming apparatus;

FIG. 3 is a perspective view of a fixing roller housing of the fixing device as viewed from bottom;

FIG. 4 is a sectional view taken along line B-B of FIG. 3;

FIG. 5 is a bottom view of the fixing roller housing;

FIG. 6 is a sectional view taken along line C-C of FIG. 5;

FIG. 7 is a sectional view similar to FIG. 6, showing another embodiment of the fixing roller housing;

FIG. 8 is a pattern diagram showing a second embodiment of the invention;

FIG. 9 is a pattern diagram showing a third embodiment of the invention;

FIG. 10 is a pattern diagram showing a fourth embodiment of the invention;

FIG. 11 is a pattern diagram showing a fifth embodiment of the invention;

FIG. 12 is a pattern diagram showing a sixth embodiment of the invention;

FIG. 13 is a pattern diagram showing a seventh embodiment of the invention;

FIG. 14 is a pattern diagram showing an eighth embodiment of the invention;

FIG. 15 is a pattern diagram showing a ninth embodiment of the invention;

FIG. 16 is a pattern diagram showing a tenth embodiment of the invention;

FIG. 17 is a pattern diagram showing an eleventh embodiment of the invention;

FIG. 18 is a pattern diagram showing a twelfth embodiment of the invention; and

FIG. 19 is a pattern diagram showing a thirteenth embodiment of the invention.

### DETAILED DESCRIPTION OF THE PREFERRED EMBODIMENTS

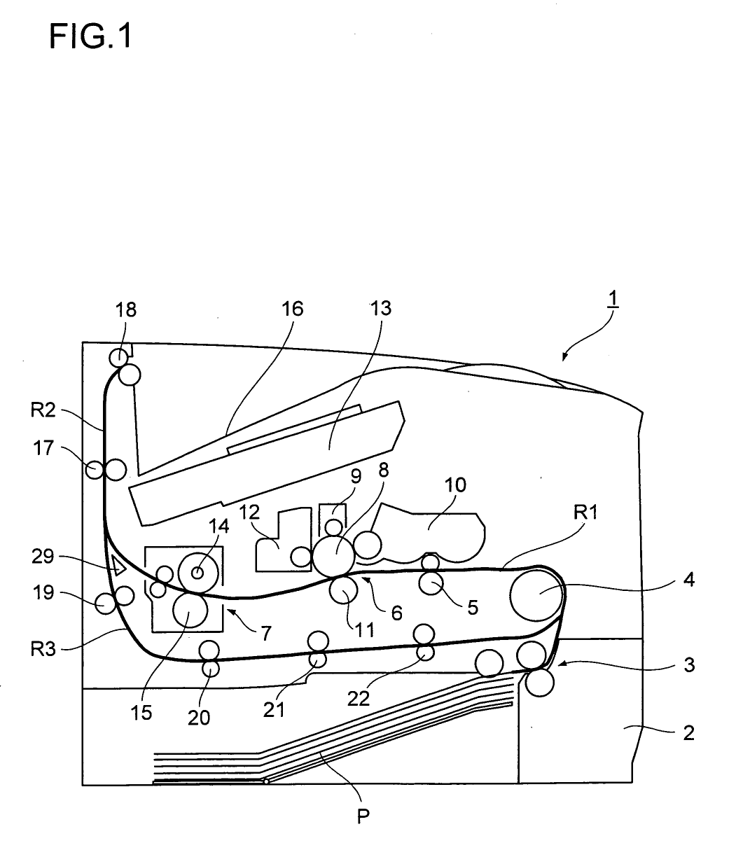

Hereinafter, the first embodiment of the present invention will be described, with reference to the accompanying drawings. FIG. 1 shows an image forming apparatus provided with a fixing device combined with a paper separating device according to the invention. The right side in the figure corresponds to a front side of the image forming apparatus. In the figure, a printer is illustrated as one example of the image forming apparatus. However, needless to say, the present invention is also applicable to an image forming apparatus other than the printer, for example, a copier.

The image forming apparatus 1 shown in FIG. 1 includes a paper feed section 2 at the bottom of the apparatus main body. The paper feed section 2 includes a paper feed cassette that stacks and stores paper P. In front of the paper feed section 2, a separating and feeding device 3 is provided which separates and feeds the stacked paper P individually, starting with the uppermost paper. Above the separating and feeding device 3, a paper conveyance path R1 is formed which conveys the paper P fed from the paper feed section 2 to a diverging section 29 located at the rear side of the apparatus. Arranged along the paper conveyance path R1 in order from the upstream side in the paper conveyance direction are: a reversing roller 4, a registration roller pair 5, an image formation section 6, and a fixing device 7.

In the image formation section 6, a photoconductive drum 8 as an electrophotographic photoreceptor is provided. Disposed around the photoconductive drum 8 are: a charging device 9 that charges the photoconductive drum 8; a developing device 10 that develops, with a toner, an electrostatic latent image formed on the photoconductive drum 8; a transfer roller 11 that transfers the toner on the photoconductive drum 8 onto paper P; and a cleaning device 12 that removes the toner remaining on the surface of the photoconductive drum 8 after the toner transfer.

Above the image formation section 6, a scanner unit 13 is arranged which focuses on the photoconductive drum 8, for example, laser light as a modulation signal generated based on image information inputted from the outside of the image forming apparatus 1.

The fixing device 7 includes: a fixing roller 14 having a heat source, such as a halogen heater, built therein; and a pressure roller 15 that makes pressure-contact with the fixing roller 14 to form a fixing nip part. The fixing device 7 forms part of a conveyance system for paper P.

Continuously with the diverging section 29 located at the downstream end of the paper conveyance path R1, a paper discharge path R2 is provided which conveys upward paper P with a toner already fixed thereon and then discharges it to a discharge tray 16 at the top of the apparatus body. At the middle of the paper discharge path R2, a conveyance roller pair 17 is arranged, and at the downstream end of the paper discharge path R2, a discharge roller pair 18 is arranged. The conveyance roller pair 17 and the discharge roller pair 18 also serve as switch-back rollers for two-sided printing.

Continuously with the diverging section 29 located at the upstream end of the paper discharge path R2, a two-sided printing conveyance path R3 is provided for conveying paper P switched back by the conveyance roller pair 17 to the image formation section 6 again. The two-sided printing conveyance path R3 extends to the bottom of the apparatus main body from the paper discharge path R2, and further extends to the front of the apparatus main body. The downstream end of two-sided printing conveyance path R3 merges with the paper conveyance path R1 at the upstream side of the reversing roller 4. Arranged along the two-sided printing conveyance path R3 in order from the upstream side in the paper conveyance direction are: two-sided conveyance roller pairs 19, 20, 21, and 22.

Image formation operation performed by the image forming apparatus 1 configured as described above will be described. First, the operation for one-sided printing will be described. When the user inputs a command for one-sided printing, laser light obtained by modulating image information by the scanner unit 13 is focused on the photoconductive drum 8 whose surface is charged by the charging device 9. Consequently, an electrostatic latent image is formed on the surface of the photoconductive drum 8.

The electrostatic latent image is developed by the developing device 10 whereby a toner image is formed on the photoconductive drum 8. Paper P individually fed from the paper feed section 2 by the separating and feeding device 3 and then reversed by the reversing roller 4 is discharged to the image formation section 6 by the registration roller pair 5 in synchronization with the toner image formation. Then the toner image formed on the photoconductive drum 8 is transferred onto the paper P by the transfer roller 11. The toner remaining on the surface of the photoconductive drum 8 without being transferred onto the paper P is removed by the cleaning device 12. The surface of the photoconductive drum 8 from which the remaining toner has been removed by the cleaning device 12 is charged again by the charging device 9.

The paper P with the toner transferred thereon is conveyed along the paper conveyance path R1 to the fixing device 7, and then heated and pressurized by the fixing roller 14 and the pressure roller 15, whereby the toner transferred on the paper P is fixed. The paper P with the toner already fixed thereon is conveyed from the paper conveyance path R1 to the paper discharge path R2, and then discharged to the discharge tray 16 by the conveyance roller pair 17 and the discharge roller pair 18.

Next, the operation for two-sided printing will be described. When the user inputs a command for two-sided printing, as is the case with the one-sided printing, a toner image is transferred onto one side of paper P. In the one-sided printing, this paper P is passed to the fixing device 7, and the paper P with a toner fixed thereon is discharged to the discharge tray 16 through the paper discharge path R2, thereby ending this operation. Contrarily, in the two-sided printing, when the rear end of the paper P with the toner fixed on the one side thereof passes through the diverging section 29 and enters the paper discharge path R2, the conveyance roller pair 17 and the discharge roller pair 18 reverse their rotation directions, whereby the paper P is pulled back into the apparatus main body. The paper P pulled pack is conveyed from the diverging section 29 to the two-sided printing conveyance path R3 without being returned to the paper conveyance path R1.

The paper P conveyed to the two-sided printing conveyance path R3 is conveyed to the front side of the apparatus main body 1 by the two-sided conveyance rollers 19, 20, 21, and 22, and returns to the paper conveyance path R1 at the upstream of the reversing roller 4. At this point, the side of the paper P where any image has not yet been formed faces upward, and on the surface of this side, the remaining image for the other side is formed. This paper P is passed to the fixing device 7, where the both sides of the paper P are fixed, and then the paper P is discharged from the paper conveyance path R1 to the discharge tray 16 via the paper discharge path R2.

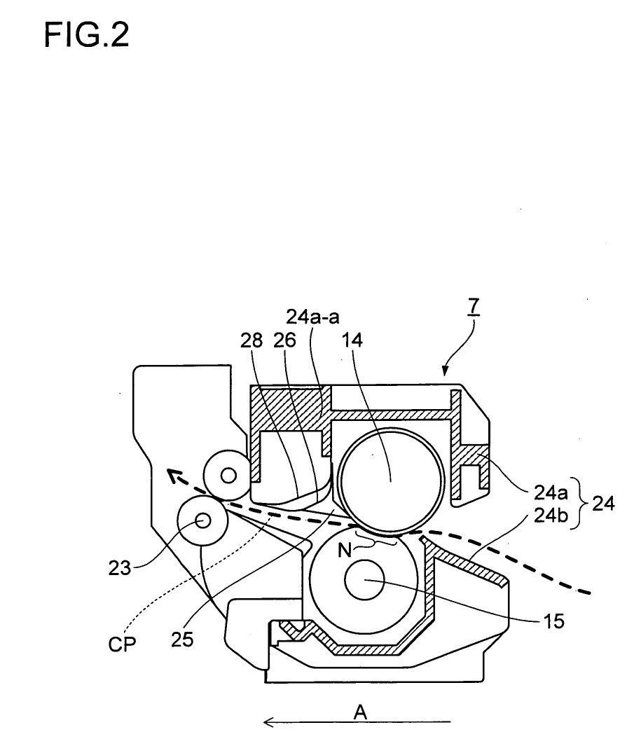

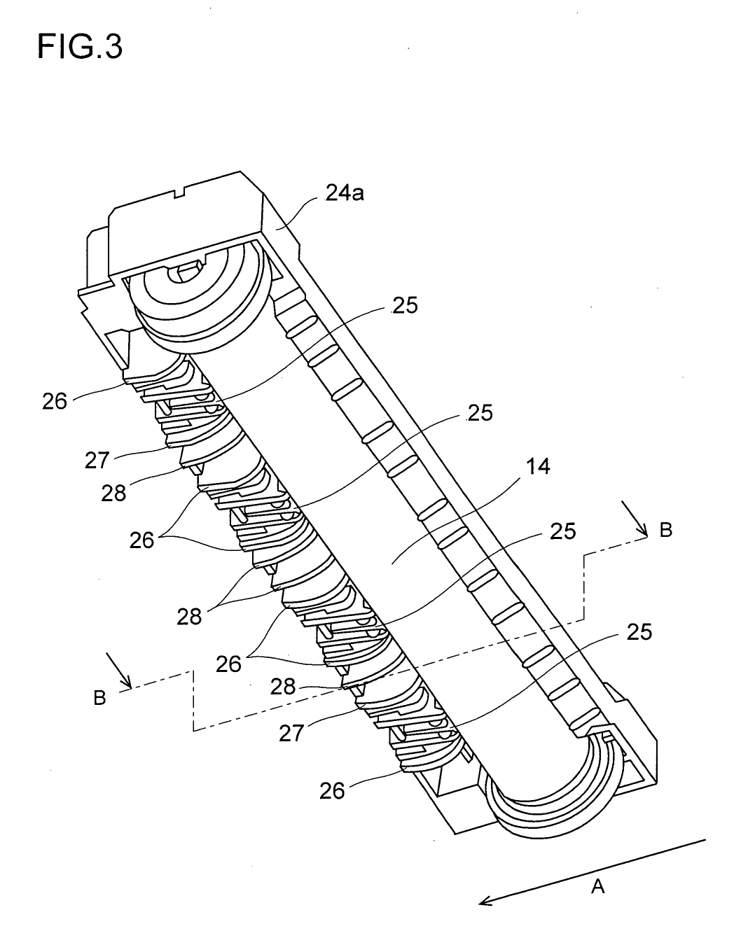

Subsequently, referring to FIGS. 2 to 6, the structure of the fixing device 7 will be described. In FIGS. 2 and 3, arrow A indicates a conveyance direction of paper P.

The fixing device 7 is composed of: the fixing roller 14, the pressure roller 15, a discharge roller pair 23, and a housing 24 for rotationally supporting these rollers. The housing 24 forms a framework of the fixing device 7, and is composed of a fixing roller housing 24a and a pressure roller housing 24b. The fixing roller housing 24a covers the fixing roller 14, and the pressure roller housing 24b covers the pressure roller 15. The paper conveyance path R1 extends, passing through between the fixing roller housing 24a and the pressure roller housing 24b. Part of the fixing roller housing 24a at the downstream side in the paper conveyance direction forms a base section 24a-a for forming guide ribs to be described later.

The fixing roller 14 is a so-called hard roller, and is formed by subjecting a hollow cylindrical metal core such as highly heat-conductive aluminum or iron to fluorine resin coating or covering it with a fluorine resin tube. Inside of the fixing roller 14, a heat source (not shown) such as a halogen heater is provided. On the other hand, the pressure roller 15 is a so-called soft roller, and is formed by forming an elastic layer of silicon rubber or the like on a cylindrical base material of synthetic resin or metal and covering the surface of the elastic layer with resin, such as fluorine resin, having excellent mold release characteristics.

The fixing roller 14 and the pressure roller 15 are arranged in such a manner as to be parallel to each other and intersect orthogonally with the conveyance direction of the paper P. The fixing roller 14 is rotationally supported by the fixing roller housing 24a, and the pressure roller 15 is rotationally supported by the pressure roller housing 24b. The pressure roller 15 is brought into pressure-contact with the fixing roller 14 with a predetermined pressure, thereby forming a fixing nip part N. While passing through the fixing nip part N, the paper P is heated and pressurized, whereby a toner in a powdery state melts and is fixed on the paper P. The paper P with the toner just fixed thereon is discharged to the outside of the fixing device 7 by the discharge roller pair 23.

The paper P makes contact with the fixing roller 14 at its top side where the toner is fixed, and has the risk of winding around the fixing roller 14 after passing through the fixing nip part N. Thus, at the downstream side of the fixing roller 14 in the paper conveyance direction, where the fixing roller 14 discharges the paper P to the downstream side of the paper conveyance path R1, separating claws are arranged. In this embodiment, as shown in FIG. 3, in the fixing roller housing 24a, separating claws 25 for separating paper from the fixing roller 14 are provided at an area downstream of the fixing nip part N in the paper conveyance direction. At least one pair of separating claws 25 is provided and so arranged as to be spaced apart form each other in the width direction of the paper P, in other words, a direction orthogonal to the paper conveyance direction. In this embodiment, four separating claws 25 in total are provided.

The separating claws 25 are combined with plate-like guide ribs extending along the paper conveyance direction for guiding the paper P separated from the fixing roller 14 by the separating claws 25 to the downstream side of the paper conveyance path R1, in this case, to the discharge roller pair 23. A plurality of guide ribs are provided in such a manner as to be spaced from each other in the paper width direction. The plurality of guide ribs include guide ribs 26, 27, and 28.

As described above, part of the fixing roller housing 24a at the downstream side thereof in the paper conveyance direction serves as the base section 24a-a for guide rib formation. The base section 24a-a is provided in such a manner as to be retracted from a paper conveyance plane (hereinafter referring to a virtual plane through which the paper P passes, and indicated by a broken line CP in FIG. 2) of the paper conveyance path R1 in a direction perpendicular to the paper conveyance plane. The guide ribs 26, 27, and 28 are formed in a manner such as to project from the fixing roller housing 24a-a toward the paper conveyance plane CP. The amount of this projection differs among the guide ribs as described later.

If the leading end, in the conveyance direction, of the paper P just separated from the fixing roller 14 by the separating claws 25 bends toward the fixing roller 14 which has been just separated therefrom, the leading end of the paper P hits the guide ribs 26, 27, and 28, possibly causing paper jam in the fixing device 7. To avoid this and reliably guide the paper P to the discharge roller pair 23, the amounts of projection of the guide ribs 26 (hereinafter referred to as “first guide ribs 26”), the guide ribs 27 (hereinafter referred to as “second guide ribs 27”), and the guide ribs 28 (hereinafter referred to as “third guide ribs 28”) toward the paper conveyance plane CP of the paper conveyance path R1 are varied from one another, the details of which will be described later.

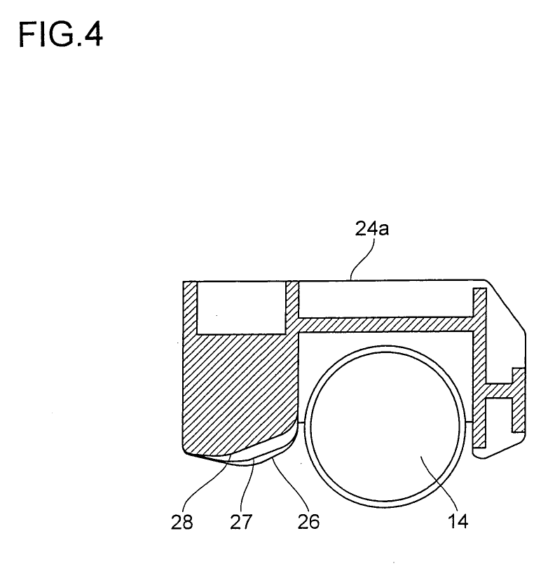

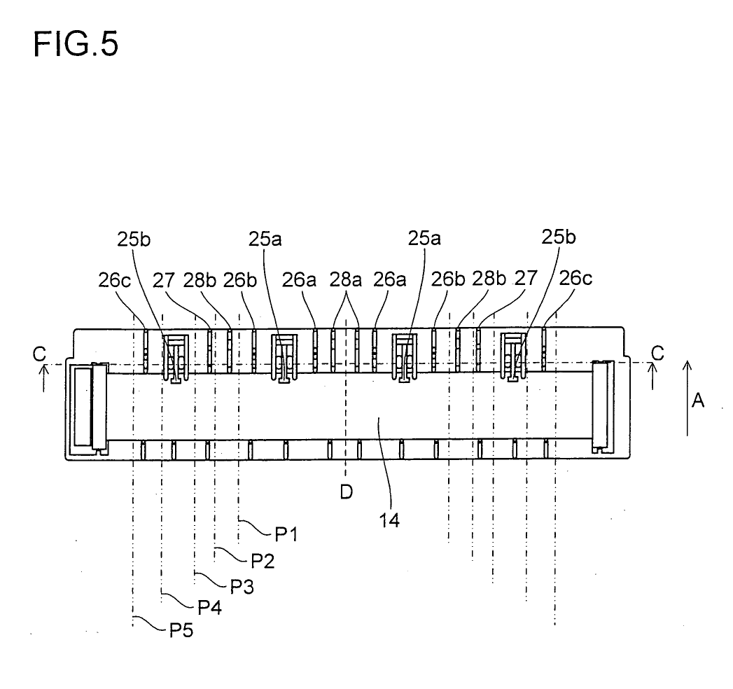

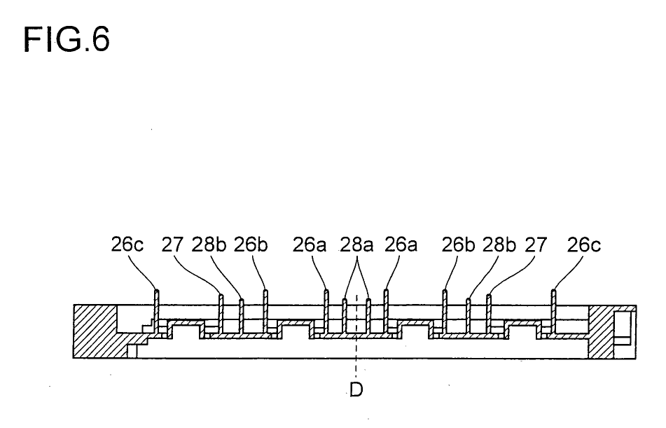

Hereinafter, referring to FIGS. 4 to 6, formation of the guide ribs, the shapes of the guide ribs, and a positional relationship between the guide ribs and the separating claws 25 will be described. In FIG. 5, arrow A indicates a conveyance direction of the paper P as in FIGS. 2 and 3. In FIGS. 4 and 6, the separating claws 25 are not illustrated for explanatory purposes.

The first guide ribs 26, the second guide ribs 27, and the third guide ribs 28 provided in the fixing roller housing 24a are respectively formed into shapes as shown in FIG. 4. These guide ribs each project toward the paper conveyance plane CP from the fixing roller housing base section 24a-a retracted perpendicularly from the paper conveyance plane CP. The amounts of their projection lengthwise of the guide ribs will be as follows. Specifically, the amount of projection toward the paper conveyance plane CP at the upstream end in the paper conveyance direction is largest for the first guide ribs 26, the second largest for the second guide ribs 27, and smallest for the third guide ribs 28. This relationship is maintained in a section between the upstream end in the paper conveyance direction and a substantially lengthwise central part of the guide ribs.

Further, the amounts of projection of the guide ribs toward the paper conveyance plane CP at the upstream ends in the paper conveyance direction form the following relationship. Specifically, out of the plurality of separating claws 25, any pair adjacent to each other is arbitrarily sampled. The base section 24a-a is provided between at least one pair of those adjacent separating claws 25. A plurality of guide ribs are provided in a manner such as to project from the base section 24a-a toward the paper conveyance plane CP. The amount of projection toward the paper conveyance plane CP differ between the plurality of guide ribs. As compared to the guide ribs adjacent to this pair of separating claws 25, the guide rib located at the middle of these guide ribs has a smaller amount of projection toward the paper conveyance plane CP at the upstream end in the paper conveyance direction.

The relationship described above will be described, referring to FIG. 6. There are a pattern of four guide ribs arranged between the pair of adjacent separating claws 25 and a pattern of three guide ribs arranged therebetween. In the pattern of four guide ribs arranged, the first guide ribs 26 are arranged on the both sides, that is, position adjacent to the pair of adjacent separating claws 25, and the two third guide ribs 28 are arranged therebetween. In the pattern of three guide ribs arranged, the first guide rib 26 and the second guide rib 27 are arranged on the both sides, that is, position adjacent to the pair of adjacent separating claws 25, and the third guide rib 28 is arranged therebetween. In either pattern, as compared to the guide ribs adjacent to the pair of adjacent separating claws 25, the guide rib located at the middle between these guide ribs has a smaller amount of projection toward the paper conveyance plane CP at the upstream end in the paper conveyance direction.

As described above, as compared to the guide ribs (the first guide rib 26 and the second guide rib 27) adjacent to the pair of adjacent separating claws 25, the guide rib (third guide rib 28) located at the middle between these guide ribs has a smaller amount of projection toward the paper conveyance plane CP at the upstream end in the paper conveyance direction, but the amount of projection of this middle guide rib (third guide rib 28) becomes larger toward the downstream side in the paper conveyance direction. Finally, the amounts of projection of all the guide ribs at the downstream ends in the paper conveyance direction become equal to each other.

The arrangement of the first, second, and third guide ribs 26, 27, and 28 and the separating claws 25 in the width direction of the paper P, in other words, a direction orthogonal to the paper conveyance direction is as shown in FIGS. 5 and 6. In the image forming apparatus 1, a paper conveyance reference position D (indicated by a broken line in FIGS. 5 and 6) is set at a widthwise central part of the paper conveyance path R1. The paper P is conveyed with its widthwise center adjusted to the paper conveyance reference position D.

With the paper conveyance reference position D provided as an axis of symmetry, four separating claws are so arranged to be bilaterally-symmetrical. Specifically, as shown in FIG. 5, the two separating claws 25a are arranged symmetrically at an area a little distant from the paper conveyance reference position D, and on the outer sides thereof, the two separating claws 25b are arranged symmetrically.

Between the left and right separating claws 25a, the two third guide ribs 28a are arranged in a manner such as to sandwich the paper conveyance reference position D, and the two first guide ribs 26a are arranged in a manner such as to sandwich these two third guide ribs 28a. Arranged between the separating claw 25a and the separating claw 25b on the left side in order from the separating claw 25a side are: the first guide rib 26b, the third guide rib 28b, and the second guide rib 27. On the outer side of the left separating claw 25b (side more distant from the paper conveyance reference position D), the first guide rib 26c is arranged. Similarly, arranged between the separating claw 25a and the separating claw 25b on the right side in order from the separating claw 25a side are: the first guide rib 26b, the third guide rib 28b, and the second guide rib 27. On the outer side of the right separating claw 25b (side more distant from the paper conveyance reference position D), the first guide rib 26c is arranged. As described above, twelve guide ribs in total are so arranged as to be spaced apart from each other in the width direction of the paper P.

Between the left and right separating claws 25a, of the four guide ribs aligned in the width direction of the paper P, those two located at the substantially central part are the third guide ribs 28a each having a smaller amount of projection toward the paper conveyance plane CP of the paper conveyance path R1 at the upstream end in the paper conveyance direction than the first guide ribs 26a on the both sides of the third guide ribs 28a. The reason for this is as described above. Similarly, between the separating claws 25a and 25b on the left side, of the three guide ribs aligned in the width direction of the paper P, the one located at the substantially central part is the third guide rib 28b having a smaller amount of projection toward the paper conveyance plane CP of the paper conveyance path R1 at the upstream end in the paper conveyance direction than the first guide rib 26b and the second guide rib 27 on the both sides of the third guide rib 28b. Between the separating claws 25a and 25b on the right side, of the three guide ribs aligned in the width direction of the paper P, the one located at the substantially central part is the third guide rib 28b having a smaller amount of projection toward the paper conveyance plane CP of the paper conveyance path R1 at the upstream end in the paper conveyance direction than the first guide rib 26b and the second guide rib 27 on the both sides of the third guide rib 28b.

As described above, when the plurality of guide ribs are arranged between the pair of adjacent separating claws 25, the guide rib located at the middle between the guide ribs adjacent to the pair of the separating claws 25 is the third guide rib 28 having a smallest amount of projection toward the paper conveyance plane CP of the paper conveyance path R1 at the upstream end in the paper conveyance direction. Thus, even when the lead end portion of the paper P in the conveyance direction bends toward the fixing roller 14 which has been just separated therefrom, the manner in which this bends is made in accordance with the amount of projection, thereby permitting the leading end of the paper P to be loaded over the guide ribs without hitting the guide ribs. This permits preventing paper jam at this area.

On the other hand, since the amounts of projection of the first, second, and third guide ribs 26, 27, and 28 toward the paper conveyance plane CP of the paper conveyance path R1 at the downstream ends in the paper conveyance direction are all made equal to each other, the paper P can be reliably and smoothly guided to the discharge roller pair 23 that is provided in the paper conveyance path R1 downstream of the first, second, and third guide ribs 26, 27, and 28.

The four separating claws 25, two each on the left and right, are so arranged as to be bilaterally-symmetrical with the paper conveyance reference position D provided as the axis of symmetry, and thus this prevents the paper P to skew when separated from the fixing roller 14. The first, second, and third guide ribs 26, 27, and 28 are also so arranged as to be bilaterally-symmetrical with the paper conveyance reference position D provided as the axis of symmetry, and thus this permits the paper P separated from the fixing roller 14 by the separating claws 25 to be guided to the discharge roller pair 23 without skewing.

The separating claws 25 and the first, second, and third guide ribs 26, 27, and 28, for paper P of ISO-standardized sizes (A series and B series), are arranged approximately 5 mm inward (an area closer to the paper conveyance reference position D) from the both widthwise ends of the respective standardized sizes. In FIG. 5, widthwise end positions of paper of standardized sizes are expressed by chain double-dashed lines. Specifically, the chain double dashed lines P1 correspond to the widthwise end positions of A6-size paper. The chain double dashed lines P2 correspond to the widthwise end positions of B6-size paper. The chain double dashed lines P3 correspond to the widthwise end positions of A5-size paper. The chain double dashed lines P4 correspond to the widthwise end positions of B5-size paper. The chain double dashed lines P5 correspond to the widthwise end positions of A4-size paper. The first guide ribs 26b, the third guide ribs 28b, the second guide ribs 27, and the first guide ribs 26c are arranged approximately 5 mm inward from the widthwise both ends of the A6-size paper, B6-size paper, A5-size paper, and A4-size paper, respectively.

With the configuration described above, even when the widthwise ends of the leading end, in the conveyance direction, of the paper P separated from the fixing roller 14 is about to curl toward the fixing roller 14, the leading end of the paper P in the conveyance direction can be loaded on the guide ribs while the degree of this curl is small. This prevents the widthwise ends of the leading end of the paper P in the conveyance direction from hitting the guide ribs and thus causing paper jam in the fixing device 7, and thus permits the paper P to be reliably guided to the discharge roller pair 23.

In the embodiment described above, for one fixing roller housing 24a, a total of four separating claws 25, and a total of 12 first, second, and third guide ribs 26, 27, and 28 are provided, although these numbers are just illustrative and thus do not limit the invention. In a case where a plurality of separating claws are so arranged as to be spaced apart from each other in the paper width direction and a plurality of guide ribs are arranged between the pair of adjacent separating claws, as long as a relationship is maintained between the pair of adjacent separating claws and the plurality of guide ribs arranged therebetween such that the guide ribs adjacent to the pair of separating claws have larger amounts of projection in the paper conveyance direction at the upstream ends in the paper conveyance direction than the guide rib located between these guide ribs, the number of separating claws and guide ribs can be arbitrarily set. Moreover, in this embodiment, the amounts of projection of the guide ribs in the paper conveyance direction are divided into three stages, and thus three kinds of guide ribs having different amounts of projection are provided, although not limited thereto.

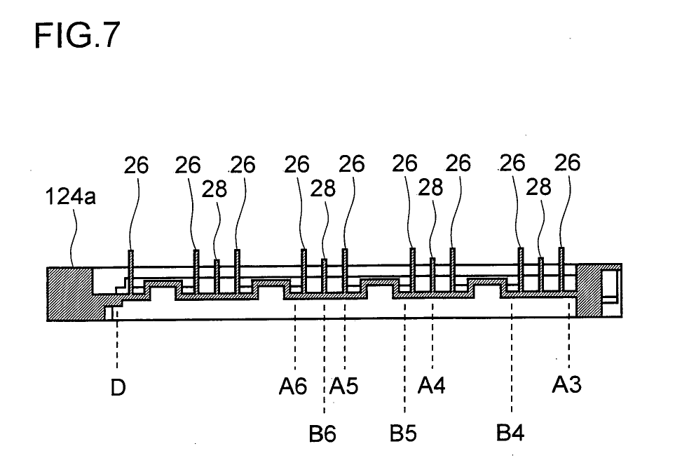

The image forming apparatus 1 is not necessarily required to be designed such that the paper conveyance reference position D is set at the widthwise central part of the paper conveyance path R1. FIG. 7 shows an example of the fixing roller housing 24a with the paper conveyance reference position D set at a different position. In the example of FIG. 7, the paper conveyance reference position D is set near the left end of the fixing roller housing 24a, so that passage of paper of sizes up to A3 is permitted. Also in this example, a plurality of separating claws are so arranged as to be spaced apart from each other in the width direction of a paper P, and a plurality of guide ribs are similarly so arranged as to be spaced apart from each other in the width direction of the paper P. A point that, in a case where a plurality of guide ribs are arranged between a pair of adjacent separating claws, as long as a relationship is maintained between at least one pair of adjacent separating claws and the plurality of guide ribs arranged therebetween such that the guide ribs adjacent to the pair of separating claws have larger amounts of projection in the paper conveyance direction at the upstream ends in the paper conveyance direction than the guide rib located between these guide ribs.

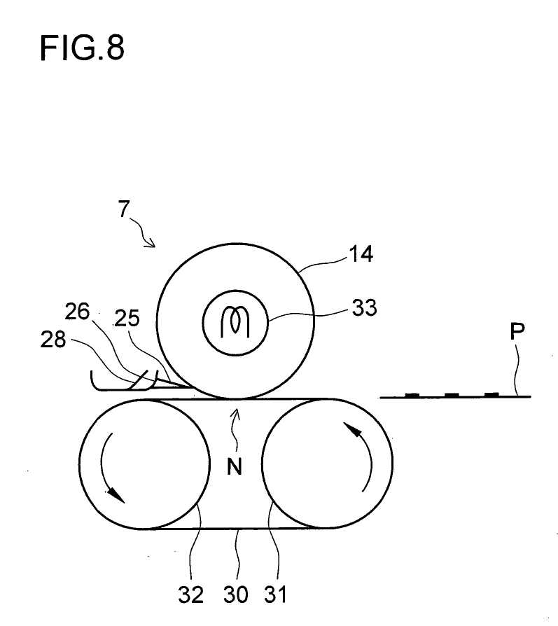

The paper separating device of the invention can also be provided at the pressure roller 15 of the fixing device 7. Moreover, a location where the paper separating device of the invention is arranged is not limited to a fixing device, as in the first embodiment, that performs fixation with a fixing roller and a pressure roller. Detailed examples where the paper separating device of the invention is arranged in fixing devices of types other than this type will be described as other embodiments, referring to FIGS. 8 to 17. In any of the following embodiments, a housing portion of the paper separating device is omitted from illustration, and only the positions of separating claws and guide ribs are illustrated.

FIG. 8 shows the second embodiment of the invention. In the second embodiment, in a fixing device 7, instead of a pressure roller, a pressure belt 30 is combined with a fixing roller 14. The pressure belt 30 is wound around a first roller 31 and a second roller 32 and pushed against the fixing roller 14, thereby forming a fixing nip part N with the fixing roller 14. The pressure belt 30, through its contact with the fixing roller 14, is driven by the fixing roller 14 as a driving source. Inside the fixing roller 14, a heat source 33 is arranged. As the heat source 33, for example, a halogen heater can be used. If the fixing roller 14 is formed of a magnetic metal, such as iron or magnetic stainless steel, that is inductively-heated (IH), instead of the halogen heater, an IH coil can be used. The same applies to the third and subsequent embodiments

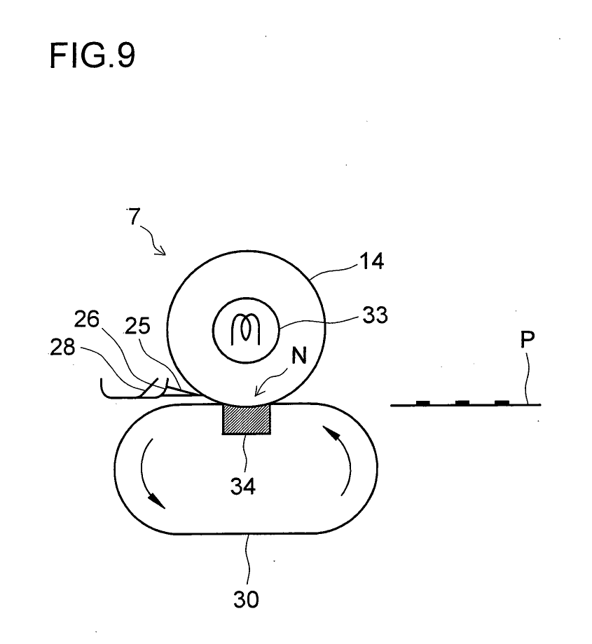

FIG. 9 shows the third embodiment of the invention. Also in the third embodiment, in a fixing device 7, a pressure belt 30 is combined with a fixing roller 14. The pressure belt 30, through its contact with the fixing roller 14, is driven by the fixing roller 14 as a driving source. This embodiment differs from the second embodiment in that the pressure belt 30 is not wound around a roller but pushed against the fixing roller 14 by a press pad 34.

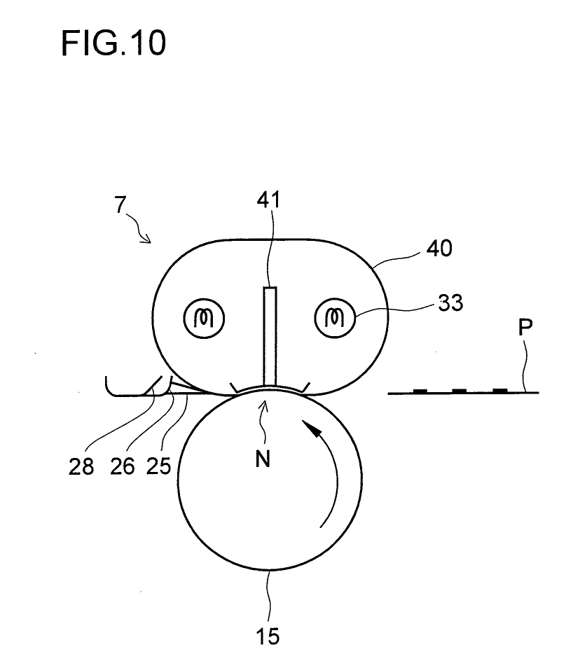

FIG. 10 shows the fourth embodiment of the invention. In the fourth embodiment, in a fixing device 7, instead of a fixing roller, a fixing belt 40 is combined with a pressure roller 15. The fixing belt 40, through its contact with the pressure roller 15, is driven by the pressure roller 15 as a driving source. Inside the fixing belt 40, a partition plate 41 is arranged which extends in the axial direction of the pressure roller 15. On the both sides of the partition plate 41, heat sources 33 are arranged which heat the fixing belt 40 from the inside.

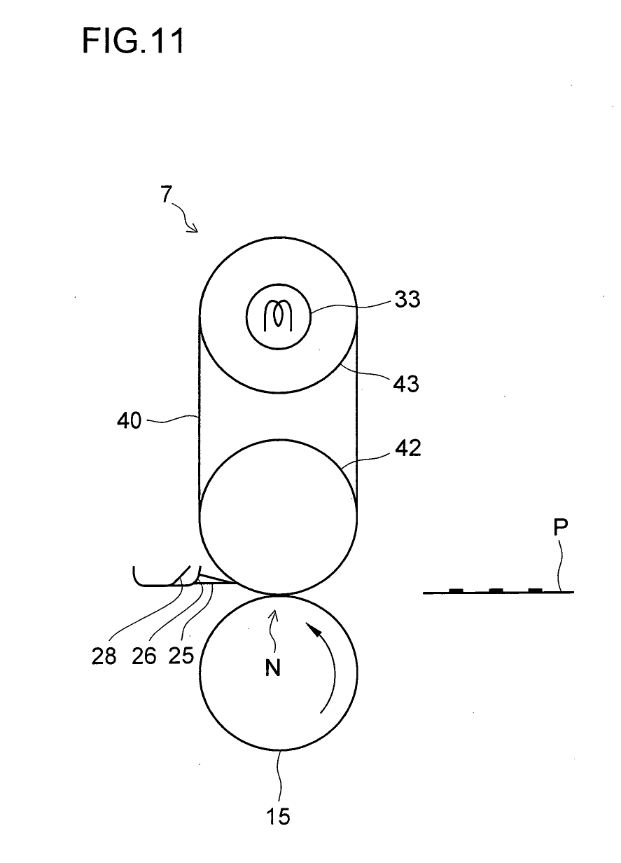

FIG. 11 shows the fifth embodiment of the invention. Also in the fifth embodiment, in a fixing device 7, a fixing belt 40 is combined with a pressure roller 15. The fixing belt 40 is wound around a first roller 42 and a second roller 43 that are vertically arranged in parallel and spaced apart from each other, and is pushed against the pressure roller 15 by the first roller 42. The pressure roller 15, through its contact with the first roller 42, is driven by the first roller 42 as a driving source. The second roller 43 is hollow, having a heat source 33 arranged therein.

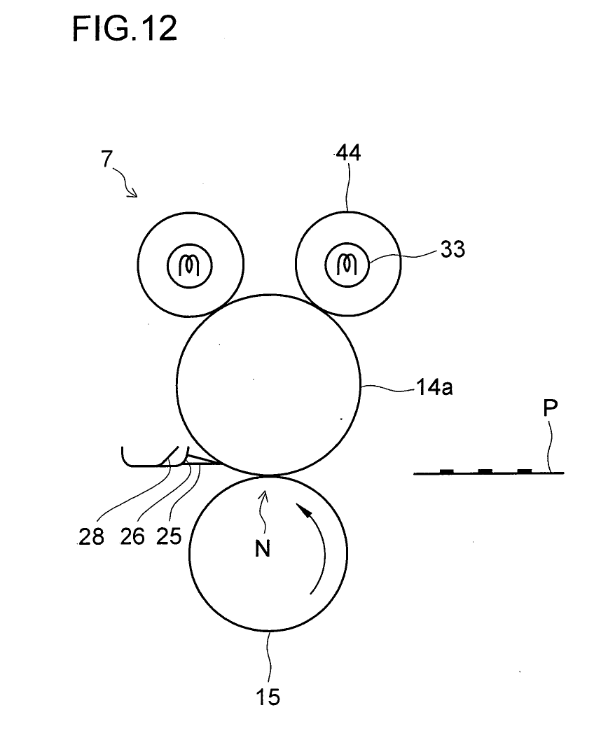

FIG. 12 shows the sixth embodiment of the invention. In the sixth embodiment, in a fixing device 7, a fixing roller 14a of a large diameter is combined with a pressure roller 15. The fixing roller 14a does not have a heat source built therein. Instead, two heat rollers 44 each having a heat source 33 built therein are pushed against the fixing roller 14a, thereby conducting a heat to the surface of the fixing roller 14a. The pressure roller 15 and the heat rollers 44, through their contact with the fixing roller 14a, are driven by the fixing roller 14a as a driving source.

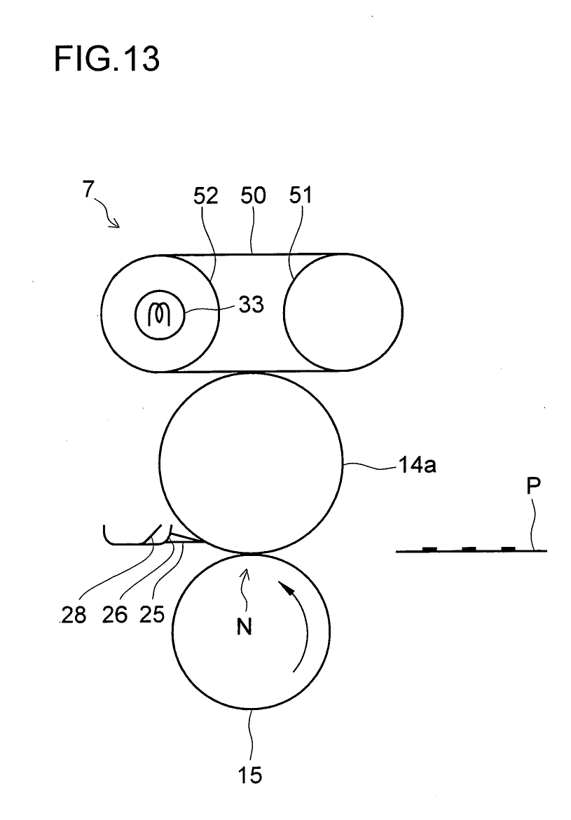

FIG. 13 shows the seventh embodiment of the invention. Also in the seventh embodiment, as in the sixth embodiment, a fixing roller 14a of a large diameter not having a heating member built therein is combined with a pressure roller 15. A heat is conducted to the surface of the fixing roller 14a by a heating belt 50. The heating belt 50 is wound around a first roller 51 and a second roller 52 horizontally arranged in parallel and spaced apart from each other, and makes contact with the fixing roller 14a. Inside of the second roller 52, a heating member 33 is arranged. The pressure roller 15 and the heating belt 50, through their contact with the fixing roller 14a, are driven by the fixing roller 14a as a driving source.

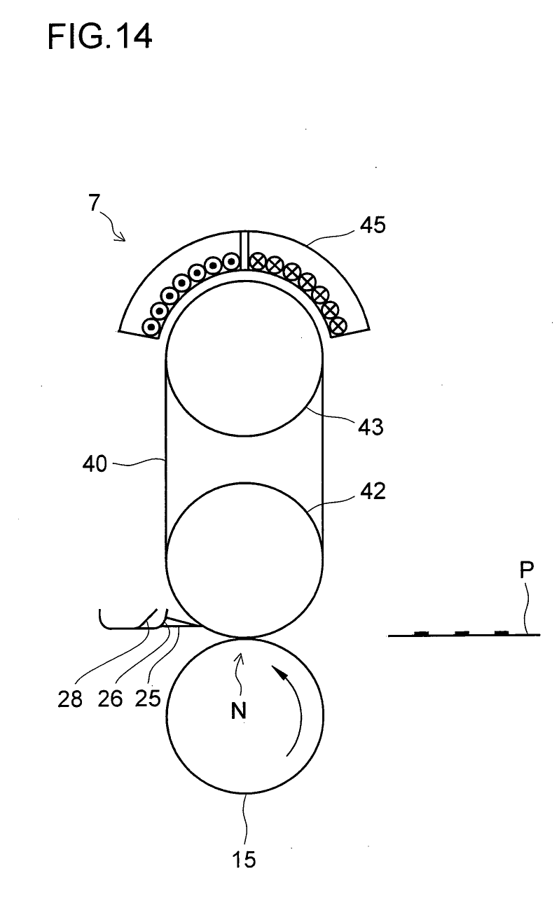

FIG. 14 shows the eighth embodiment of the invention. In the eighth embodiment, as in the firth embodiment of FIG. 10, in a fixing device 7, a fixing belt 40 is combined with a pressure roller 15. The fixing belt 40 is wound around a first roller 42 and a second roller 43 vertically arranged in parallel and spaced apart from each other, and is pushed against the pressure roller 15 by the first roller 42. The pressure roller 15, through its contact with the first roller 42, is driven by the first roller 42 as a driving source. Unlike in the fifth embodiment, the second roller 43 does not have a heat source built therein. The fixing belt 40 is heated by an IH coil 45 surrounding the second roller 43 in a semicircular form. Needless to say, the fixing belt 40 is formed of a magnetic metal, such as iron or magnetic stainless steel, that is inductively-heated.

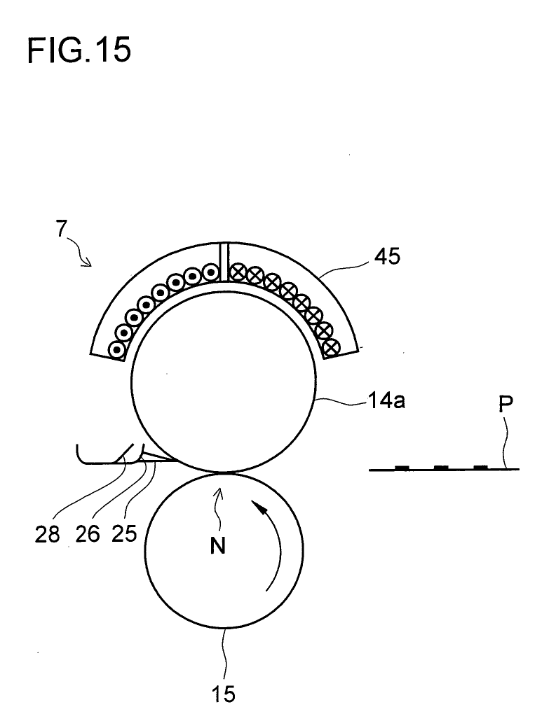

FIG. 15 shows the ninth embodiment of the invention. In the ninth embodiment, as in the sixth embodiment of FIG. 12, in a fixing device 7, a fixing roller 14a of large diameter is combined with a pressure roller 15. The pressure roller 15, through its contact with the fixing roller 14a, is driven by the fixing roller 14a as a driving source. The fixing roller 14a is heated by an IH coil 45 surrounding the fixing roller 14a in a semicircular form. Needless to say, the fixing roller 14a is formed of a magnetic metal, such as iron or magnetic stainless steel, which is inductively-heated.

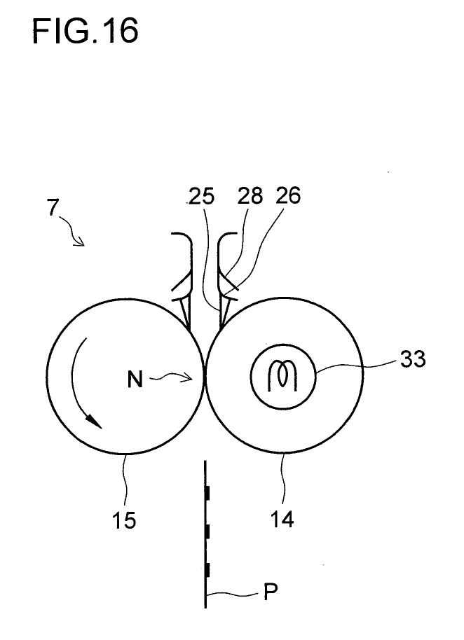

FIG. 16 shows the tenth embodiment of the invention. In the tenth embodiment, in a fixing device 7, a fixing roller 14 and a pressure roller 15 are arranged horizontally, and a paper conveyance path R1 passes perpendicularly through between the both rollers. The pressure roller 15, through its contact with the fixing roller 14, is driven by the fixing roller 14 as a driving source. For both the fixing roller 14 and the pressure roller 15, separating claws 25 and a group of guide ribs composed of first, second, third guide ribs 26, 27, 28, etc. are provided.

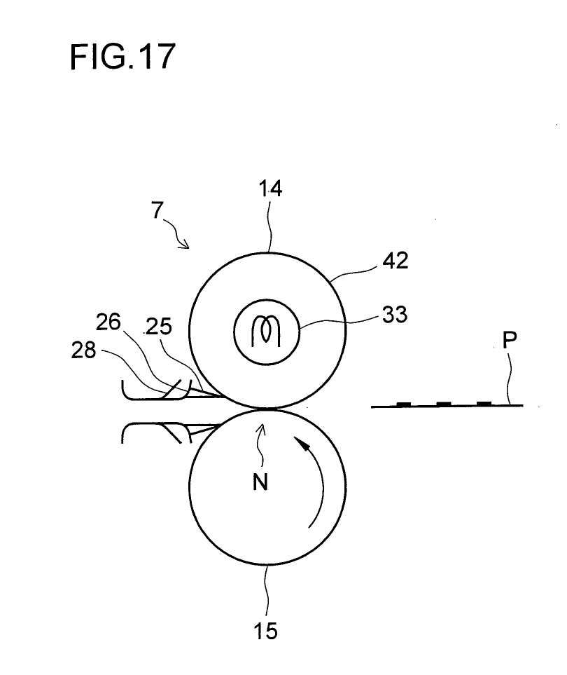

FIG. 17 shows the eleventh embodiment of the invention. In the eleventh embodiment, as in the first embodiment, in a fixing device 7, a fixing roller 14 and a pressure roller 15 are arranged vertically, and a paper conveyance path R1 passes horizontally through between the both rollers. The pressure roller 15, through its contact with the fixing roller 14, is driven by the fixing roller 14 as a driving source. For both the fixing roller 14 and the pressure roller 15, separating claws 25 and a group of guide ribs composed of first, second, third guide ribs 26, 27, 28, etc. are provided.

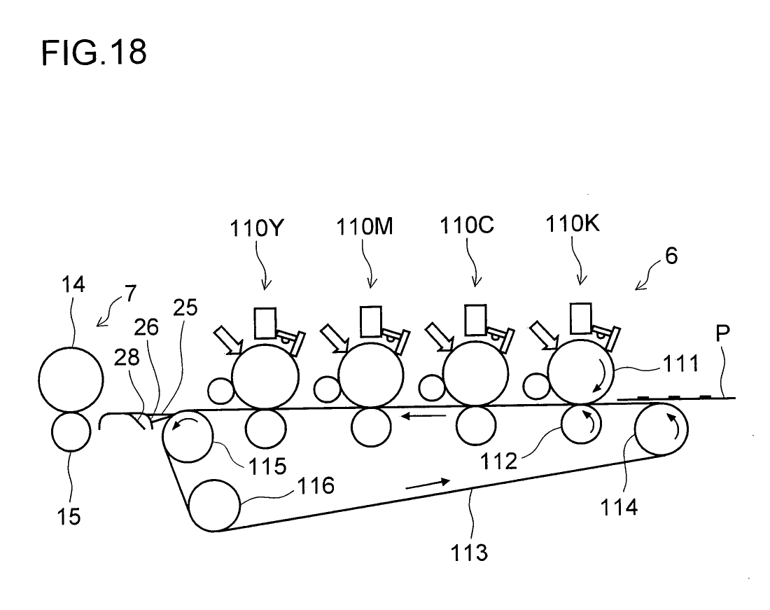

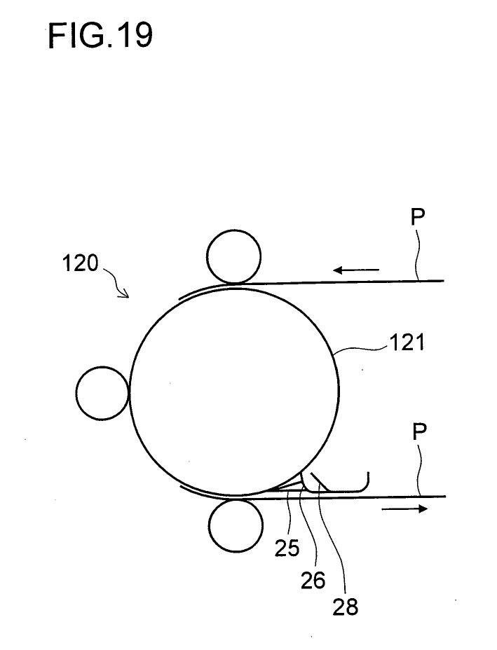

The paper separating device of the invention can also be arranged in a device other than the fixing device. Detailed examples of this will be described as other embodiments, referring to FIGS. 18 and 19.

FIG. 18 shows the twelfth embodiment of the invention. In the twelfth embodiment, at an area where paper P with a toner transferred thereon is discharged from an image formation section 6 to a fixing part 7, a separating claw 25 and a group of guide ribs composed of first, second, third guide ribs 26, 27, 28, etc. are provided. The image formation section 6 illustrated in FIG. 18 is of a tandem type for color image formation and includes: image forming units for different colors including an yellow unit 110Y, a magenta unit 110M, a cyan unit 110C, and a black unit 110B; and a conveyer belt 113 revolving through between a photoconductive drum 111 and a transfer roller 112 of each of the image forming units. Needless to say, the conveyer belt 113 forms part of a conveyance system for the paper P.

The conveyer belt 113 revolves around rollers 114, 115, and 116 while being wound therearound, and conveys the paper P by electrostatic adhesion. At the roller 115, separating claws 25 and a guide rib group are arranged. The paper P with toners of the different colors transferred thereon by the image forming units for the different colors, upon reaching the roller 115, is separated from the conveyer belt 113 by the separating claw 25 and guided to the fixing device 7 by the guide rib group.

FIG. 19 shows the thirteenth embodiment of the invention. FIG. 19 illustrates a paper conveying device 120 forming part of a paper conveyance system. The paper conveying device 120 has a conveyance roller 121 of a large diameter rotating axially, and paper P is conveyed along the circumferential surface of the conveyance roller 121 in a manner closely attached thereto and also inverted through 180 degrees.

In the paper conveying device 120, in a case where paper P having low stiffness, such as thin paper P, is conveyed, the paper P is likely to be wound around the conveyance roller 121. To prevent such winding and smoothly guide the paper P to the downstream side in the paper conveyance direction, a separating claw 25 and a guide rib group composed of first, second, third guide ribs 26, 27, 28, etc. are arranged on the paper exit side of the conveyance roller 121.

The paper conveying device 120 can be arranged at the following area. For example, the reversing roller 4 of the image forming apparatus 1 of the first embodiment can be replaced with the paper conveying device 120. In addition, in a case where the image forming apparatus 1 of the first embodiment is combined with a document handling device or a paper after-treatment device, the paper conveying device 120 can be provided in paper conveyance paths of these devices.

The present invention has been described, referring to the several embodiment s above, although the invention is not limited thereto. Thus, various modifications can be made without departing the scope and spirits of the invention.

What is claimed is:

1. A paper separating device comprising:
a conveying member arranged in a paper conveyance path, the conveying member conveying paper in contact therewith;
a plurality of separating claws arranged downstream of the conveying member, the separating claws separating the paper from the conveying member and guiding the paper to a downstream side of the paper conveyance path; and
a plurality of guide ribs arranged between a pair of the adjacent separating claws, the guide ribs guiding the paper separated from the conveying member by the separating claws to the downstream side of the paper conveyance path,
wherein the guide ribs project toward a paper conveyance plane from a base section provided between the pair of the adjacent separating claws, and
wherein the guide ribs further include the guide ribs adjacent to the pair of the separating claws, and the guide rib having a smaller amount of projection toward the paper conveyance plane at an upstream end in a paper conveyance direction than the guide ribs adjacent to the pair of the separating claws.

2. The paper separating device according to claim 1,
wherein a paper conveyance reference position is set at a widthwise central part of the paper conveyance path, and
wherein the separating claws are so arranged as to be symmetrical with the paper conveyance reference position provided as an axis of symmetry.

3. The paper separating device according to 1,
wherein a paper conveyance reference position is set at a widthwise central part of the paper conveyance path, and
wherein the guide ribs are so arranged as to be symmetrical with the paper conveyance reference position provided as an axis of symmetry.

4. The paper separating device according to claim 1,
wherein the guide rib having a smaller amount of projection toward the paper conveyance plane than the guide ribs adjacent to the pair of the separating claws has the amount of projection becoming larger toward a downstream side in the paper conveyance direction, and the amount of projections of all the guide ribs become equal to each other at downstream ends in the paper conveyance direction.

5. A fixing device comprising:
a fixing member and a pressure member arranged in a paper conveyance path, the fixing member and the pressure member passing paper through a fixing nip part formed therebetween;
a plurality of separating claws arranged downstream of the fixing member or the pressure member, the separating claws separating the paper from the fixing member or the pressure member and guiding the paper to a downstream side of the paper conveyance path; and
a plurality of guide ribs arranged between a pair of the adjacent separating claws, the guide ribs guiding the paper separated from the fixing member or the pressure member by the separating claws to the downstream side of the paper conveyance path,
wherein the guide ribs project toward a paper conveyance plane from a base section provided between the pair of the adjacent separating claws, and
wherein the guide ribs further include the guide ribs adjacent to the pair of the separating claws, and the guide rib having a smaller amount of projection toward the paper conveyance plane at an upstream end in a paper conveyance direction than the guide ribs adjacent to the pair of the separating claws.

6. A paper conveying device comprising:
a conveying member arranged in a paper conveyance path, the conveying member conveying paper in contact therewith;
a plurality of separating claws arranged downstream of the conveying member, the separating claws separating the paper from the conveying member and guiding the paper to a downstream side of the paper conveyance path; and
a plurality of guide ribs arranged between a pair of the adjacent separating claws, the guide ribs guiding the paper separated from the conveying member by the separating claws to the downstream side of the paper conveyance path,
wherein the guide ribs project toward a paper conveyance plane from a base section provided between the pair of the adjacent separating claws, and
wherein the guide ribs further include the guide ribs adjacent to the pair of the separating claws, and the guide rib having a smaller amount of projection toward the paper conveyance plane at an upstream end in a paper conveyance direction than the guide ribs adjacent to the pair of the separating claws.

7. The paper conveying device according to claim 6,
wherein the conveying member is a conveyer belt revolving while being wound around a plurality of rollers.

8. The paper conveying device according to claim 6,
wherein the conveying member is a conveyance roller axially rotating.

9. An image forming apparatus comprising:
a conveying member arranged in a paper conveyance path, the conveying member conveying paper in contact therewith;
a plurality of separating claws arranged downstream of the conveying member, the separating claws separating the paper from the conveying member and guiding the paper to a downstream side of the paper conveyance path; and
a plurality of guide ribs arranged between a pair of the adjacent separating claws, the guide ribs guiding the paper separated from the conveying member by the separating claws to the downstream side of the paper conveyance path,
wherein the guide ribs project toward a paper conveyance plane from a base section provided between the pair of the adjacent separating claws, and
wherein the guide ribs further include the guide ribs adjacent to the pair of the separating claws, and the guide rib having a smaller amount of projection toward the paper conveyance plane at an upstream end in a paper conveyance direction than the guide ribs adjacent to the pair of the separating claws.
